(19) United States
(12) Patent Application Publication
(10) Pub. No.: US 2022/0119683 A1
(43) Pub. Date: Apr. 21, 2022

(54) Reworkable Optical Clear Adhesive

(71) Applicant: Hewlett-Packard Development Company, L.P., Spring, TX (US)

(72) Inventors: Kuan-Ting Wu, Taipei City (TW); Super Liao, Taipei City (TW); Hsing-Hung Hsieh, Taipei City (TW)

(73) Assignee: Hewlett-Packard Development Company, L.P., Spring, TX (US)

(21) Appl. No.: 17/293,232

(22) PCT Filed: Jul. 10, 2019
(86) PCT No.: PCT/US2019/041252

§ 371 Date: May 12, 2021

(51) Int. Cl. C09J 7/35; C09J 7/10

(52) U.S. Cl. CPC C09J 7/35; C09J 2479/00; C09J 2203/326; C09J 2301/304; C09J 2301/416; C09J 2423/10; C09J 2423/04; C09J 2431/00; C09J 2433/006; C09J 2455/006; C09J 2463/00; C09J 2467/00; C09J 2469/006; C09J 2475/00; C09J 7/10

(57) ABSTRACT

A reworkable optically clear adhesive composition, a method for adjoining a light source to a light guide plate by applying a reworkable optically clear adhesive composition to the light guide plate, and a lighting device comprising a light source, a light guide plate and a reworkable optically clear adhesive film are described. The reworkable optically clear adhesive composition has a processing temperature of between about 50° C. and about 80° C. and comprises: from about 15 wt. % to about 40 wt. % hot melt adhesive; from about 20 wt. % to about 60 wt. % optical resin; and from about 10 wt. % to about 40 wt. % UV adhesive, wherein the weight percentage of each component is based on the total weight of the reworkable optically clear adhesive composition.

Lighting devices comprising a light source and a light guide plate are assembled using adhesive compositions to adjoin the light source to the light guide plate. Typically, the adhesive composition is applied between the light source and light guide plate and cured. Such adhesive compositions should not adversely affect the function of the lighting device as a light source and be compatible with the adjoined materials.

### BRIEF DESCRIPTION OF THE FIGURES

FIG. 1 is a partial cross-sectional diagram showing a lighting device comprising a light source, a light guide plate and a reworkable optically clear adhesive film.

The figures depict several examples of the present disclosure. It should be understood that the present disclosure is not limited to the examples depicted in the figures.

### DETAILED DESCRIPTION

Before the reworkable optically clear adhesive composition, method for adjoining a light source to a light guide plate by applying a reworkable optically clear adhesive composition and a lighting device comprising a light source, a light guide plate and a reworkable optically clear adhesive film and related aspects are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a”, “an” and “the” include plural referents unless the context clearly dictates otherwise.

If a standard test is mentioned herein, unless otherwise stated, the version of the test to be referred to is the most recent at the time of filing this patent application.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt,%” should be interpreted to include not only the explicitly recited values of about 1 wt. % to about 5 wt. %, but also include individual values and subranges within the indicated range. Thus, included in this numerical range are individual values such as 2, 3.5, and 4 and sub-ranges such as from 1-3, from 2-4, and from 3.5, etc. This same principle applies to ranges reciting only one numerical value. Furthermore, such an interpretation should apply regardless of the breadth of the range or the characteristics being described.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “reworkable” when used to refer to the optically clear adhesive composition and optically clear adhesive film means that once the said adhesive composition or adhesive film is applied to a substrate it may be removed partially or in its entirely and reapplied without damage to the substrate. The reworkable optically clear adhesive composition and the reworkable optically clear adhesive film can be reworked at a processing temperature, or process temperature range, specific to the composition of the adhesive composition.

As used herein, the term “processing temperature” is a temperature at which the reworkable optically clear adhesive composition can be heated to make the material malleable enough for it to be removed from the substrate and repositioned onto the substrate without damaging the substrate.

As used herein, the term “substrate” is used to refer the object to which the reworkable optically clear adhesive composition or the reworkable optically clear adhesive film is applied. The term “substrate” is a general term and is used herein to encompass specific objects including, for example, a light guide plate and a light source.

As used herein, the term “optically clear” is used to refer to transmission of a film of 90% or greater measured in accordance with ASTM D1003 at 550 nm.

Unless otherwise stated, “adhesive composition” used herein refers to “reworkable optically clear adhesive composition”, and “adhesive film” used herein refers to “reworkable optically clear adhesive film”.

As used herein, the term “adhesive composition” encompasses the term “adhesive film”. The term “adhesive film” as used herein is the adhesive composition in the form of a film or layer.

As used herein, the term “comprises” has an open meaning, which allows other, unspecified features to be present. This term embraces, but is not limited to, the semi-closed term “consisting essentially of” and the closed term “consisting of”. Unless the context indicates otherwise, the term ‘comprises’ may be replaced with either “consisting essentially of” or “consists of”.

Unless otherwise stated, any feature described herein can be combined with any aspect or any other feature described herein.

In an aspect, there is provided a reworkable optically clear adhesive composition with a processing temperature of between about 50° C. and about 80° C. comprising:
from about 15 wt % to about 40 wt. % hot melt adhesive;
from about 20 wt. % to about 60 wt. % optical resin; and
from about 10 wt. % to about 40 wt. % UV adhesive,

wherein the weight percentage of each component is based on the total weight of the reworkable optically clear adhesive composition.

In another aspect, there is provided a method for adjoining alight source to a light guide plate comprising:
applying a reworkable optically clear adhesive composition with a processing temperature of about 50° C. to about 80° C. comprising:
   from about 15 wt. % to about 40 wt. % hot melt adhesive;
   from about 20 wt. % to about 60 wt. % optical resin; and
   from about 10 wt. % to about 40 wt. % UV adhesive.
to a light source and/or a light guide plate to form a reworkable optically clear adhesive film, wherein the weight percentage of each component is based on the total weight of the reworkable optically clear adhesive composition; adjoining the light source to the light guide plate with the adhesive film therebetween; and
curing the reworkable optically clear adhesive film by treating with UV light.

In a further aspect, there is provided a lighting device comprising a light source, a light guide plate and a reworkable optically clear adhesive film, wherein the reworkable optically clear adhesive film has a processing temperature of between about 50° C. and about 80° C. and comprises:
from about 15 wt. % to about 40 wt. % hot melt adhesive;
from about 20 wt. % to about 60 wt. % optical resin; and
from about 10 wt. % to about 40 wt. % UV adhesive,

wherein the weight percentage of each component is based on the total weight of the reworkable optically clear adhesive film.

Reworkable Optically Clear Adhesive Composition

The reworkable optically clear adhesive composition may have a processing temperature of between about 50° C. to about 80° C. For example, the reworkable optically clear adhesive composition may have a processing temperature of between about 55° C. and about 75° C., or between about 60° C. and about 70° C. At a processing temperature the reworkable optically clear adhesive composition is malleable to allow the adhesive composition to be removed from the substrate and reapplied to the substrate. In this way, the application of the adhesive composition onto the substrate can be corrected to remove, for example, any kinks in the adhesive composition. The readjustment of the adhesive composition also allows any air bubbles formed by the kinks in the adhesive composition or any air bubbles between the adhesive composition and the substrate to be removed. Application of the adhesive composition in this way allows the distance between the two adjoined substrates to be kept to a minimum. The processing temperature of no more than 80° C. also allows the adhesive composition to be used on substrates that do not tolerate higher temperatures.

Hot Metal Adhesive

Hot melt adhesives are thermoplastic in nature and are solid at room temperature. Hot metal adhesives may be selected from ethylene vinyl acetate (EVA), polypropylene, polyamide, polyurethane and combinations thereof.

The hot melt adhesive may be present in the reworkable optically clear adhesive composition in an amount of from about 15 wt. % to about 40 wt. %, based on the total weight of the reworkable optically clear adhesive composition. For example, the reworkable optically clear adhesive composition may comprise a hot melt adhesive in an amount of from about 18 wt. % to about 37 wt. %, or from about 20 wt. % to about 35 wt. %, 20 or from about 22 wt. % to about 33 wt. %, or from about 25 wt. % to about 30 wt. %, or from about 27 wt. % to about 29 wt. %, based on the total weight of the reworkable optically clear adhesive composition.

Optical Resin

Optical resins are clear gel adhesives that are optically clear. Optical resins may be selected from polyacrylic, polymethylmethacrylate (PMMA), polycarbonate, polyester, and cyclic olefin copolymer (COC) and combinations thereof.

The optical may be present in the reworkable optically clear adhesive composition in an amount of from about 20 wt. % to about 60 wt. %, based on the total weight of the reworkable optically clear adhesive composition. For example, the reworkable optically clear adhesive composition may comprises an optical resin in an amount of from about 23 wt. % to about 57 wt. %, or from about 25 wt. % to about 55 wt. %, or from about 27 wt,% to about 52 wt. %, or from about 30 wt. % to about 50 wt. %, or from about 33 wt. % to about 48 wt. %, or from about 35 wt. % to about 45 wt. %, or from about 38 wt. % to about 42 wt. %, based on the total weight of the reworkable optically clear adhesive composition.

UV Adhesive

UV adhesives are adhesives that can be cured under UV light. UV adhesives may be selected from epoxy adhesives, polyurethane acrylate adhesives, silicone adhesives and combinations thereof.

The UV adhesive may be present in the reworkable optically clear adhesive composition in an amount of from about 10 wt. % to about 40 wt. %, based on the total weight of the reworkable optically clear adhesive composition. For example, the reworkable optically clear adhesive composition may comprise a UV adhesive in an amount of from about 12 wt % to about 37 wt. %, or from about 15 wt. % to about 35 wt. %, or from about 17 wt % to about 32 wt. %, or from about 20 wt % to about 30 wt. %, or from about 23 wt. % to about 28 wt. %, based on the total weight of the reworkable optically clear adhesive composition.

Catalyst

The reworkable optically clear adhesive composition may comprise a catalyst. The catalyst may be selected from sodium tantalite, titanium dioxide, dibutyl tin dilaurate (DBT), tetrabutyl titanate and nickel oxide.

The catalyst may be present in the reworkable optically clear adhesive composition in an amount of from about 0.05 wt. % to about 0.15 wt. %, based on the total weight of the reworkable optically clear adhesive composition. For example, the reworkable optically clear adhesive composition may comprise a catalyst in an amount of from about 0.07 wt. % to about 0.13 wt. %, or from about 0.10 wt. % to about 12 wt. %, based on the total weight of the reworkable optically clear adhesive composition.

Preparing a Reworkable Optically Clear Adhesive Composition and Applying to a Substrate

A reworkable optically clear adhesive composition is prepared by blending the hot melt adhesive, the optical resin and the UV adhesive together in the presence of a solvent.

The solvent may be selected from methyl ethyl ketone, methyl isobutyl ketone, ethyl acetate, butyl acetate, propylene glycol monomethyl ether, ethylene glycol mono tert-buthyl ether, dipropylene glycol methyl ether, isobutyl alcohol and mixtures thereof.

The solvent may be present in the adhesive composition in an amount of from about 25 wt. % up to about 45 wt. % based on the total weight of the reworkable optically clear adhesive composition. For example, the adhesive composition may comprise solvent in an amount of up to 40 wt. %, or up to 37 wt. %, or up to 35 wt. %, or up to 32 wt. %, or up to 30 wt. %, or up to 28 wt. %, or up to 25 wt. % based on the total weight of the reworkable optically clear adhesive composition.

The adhesive composition obtained from the blending step is then applied to a substrate, which may be alight guide plate. The adhesive composition is applied in such as way as to form an adhesive film on parts of the substrate that is to be adjoined to a second substrate, such as a light source.

The adhesive film may have a thickness of from about 5 μm to about 500 μm. For example, the adhesive film may have a thickness of from 10 μm to about 450 μm, or from 20 μm to about 400 μm, or from 30 μm to about 350 μm, or from 40 μm to about 300 μm, or from 50 μm to about 250 μm, or from 60 μm to about 200 μm, or from 70 μm to about 150 μm, or from 80 μm to about 100 μm. The thickness of the film can be measured using an electromagnetic testing method. For example, ASTM E376-19 entitled “Standard practice for Measuring Coating Thickness by Magnetic-Field or Eddy Current (Electromagnetic) Testing Methods” can be used to measure the thickness of the adhesive film.

The adhesive composition applied to the substrate may have a viscosity of from about 10,000 to about 100,000 cps. For example the adhesive composition applied to the substrate may have a viscosity of from about 15,000 to about 90,000 cps, or from about 20,000 to about 80,000 cps, from about 30,000 to about 70,000 cps, or from about 40,000 to about 60,000 cps. The viscosity of the adhesive composition can be measured using, for example, ASTM D1084 entitled “Standard Test Methods for Viscosity of Adhesives”. Operating within the said viscosity range provides a high enough viscosity for the adhesive composition to be applied where intended and for it not to run into other areas, as is often experienced with liquid adhesive. Therefore, the adhesive compositions may be easy to use, handle, apply or store.

The adhesive film on the substrate is then heated to a temperature of between 50° C. to 80° C. for about 5 to 20 minutes. During this step some or all of the solvent may evaporate. At this stage, the adhesive film may be repositioned.

A second substrate is then positioned on the open surface of the adhesive film. The adhesive film is then cured by exposure to UV light. The exposure to UV light may be at a dose of about 700 to about 1500 mJ/cm³ for 10 to 30 seconds. Curing using UV light may be carried out before positioning the second substrate to the open surface of the adhesive film.

The reworkable optically clear adhesive film may at any time be heated to a processing temperature of between about 50° C. and about 80° C. and partially or totally removed from the substrate. Reworking the adhesive film may be carried out before or after curing by exposure to UV light.

The adhesive film may have at shear strength, after curing, of from about 3 MPa to about 25 MPa. For example, the adhesive film may have a shear strength, after curing, of from about 5 MPa to about 22 MPa, or from about 8 MPa to about 20 MPa, or from about 10 MPa to about 18 MPa, or from about 13 MPa to about 16 MPa. The shear strength of the adhesive film may be measured using a standard method. For example, the shear strength can be measured using ASTM D4562 entitled “Standard Test Method for Shear Strength of Adhesives Using Pin-and-Collar Specimen”.

The adhesive film may have a glass transition temperature (Tg), after curing, of from about 20° C. to about 260° C. For example, the adhesive film may have a glass transition temperature of from about 30° C. to about 250° C., or from about 40° C. to about 230° C. or from about 50° C. to about 210° C., or from about 60° C. to about 90° C., or from about 70° C. to about 80° C. The glass transition temperature of the adhesive film may be measured using a standard method. For example, the glass transition temperature can be measured using ASTM E1356 entitled “Standard Test Method for Assignment of the Glass Transition Temperatures by Differential Scanning Calorimetry”.

Lighting Device

A lighting device comprises a light source, a light guide plate and a reworkable optically clear adhesive film. The lighting device may be a sign, computer, a laptop, a tablet, a workstation, a cell phone, a portable networking device, a portable gaming device and a portable GPS

Light Source

The light source may be an LED light. For example, the light source may be an LED bar with a length of from about 0.01 m to about 2 m.

Light Guide Plate

A light guided plate (LGP) may be made of a material selected from poly(methyl methacrylate), polycarbonate, acrylonitrile butadiene styrene and combinations thereof.

The light guided plate may have a thickness of from about 0.2 to 10 mm. For example, 15 the light guided plate may have a thickness of from about 0.6 mm to about 9 mm, or from about 0.6 mm to about 8 mm, or from about 1 mm to about 7 mm, or from about 2 mm to about 8 mm, or from about 3 mm to about 5 mm.

### EXAMPLES

The following illustrates examples of the methods and other aspects described herein.

Thus, these Examples should not be considered as limitations of the present disclosure, but are merely in place to teach how to make examples of the present disclosure.

### Example 1

Adhesive composition A was prepared by blending the following components:
20 wt. % ethylene vinyl acetate (Hot melt adhesive)
25 wt. % PMMA (Optical resin)
20 wt. % polyurethane acrylate (UV adhesive)
0.6 wt % polymethylmethacrylate (Thickener)
34.3 wt % Methyl ethyl ketone (Solvent)
0.1 wt % tetrabutyl titanate. TBT, (Catalyst)

To a light guide plate (351.6 mm×202.3 mm×0.4 mm) made of PMMA the adhesive composition A was applied to form an adhesive film and dried at 55° C. for 10 minutes.

The adhesive film was UV cured by exposure to a UV light source with a wavelength of 340 nm at 1200 mJ/cm³. A LED bar was then positioned on the adhesive film to adjoin the LGP to the LED bar.

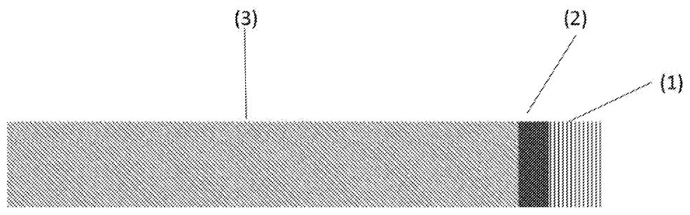

A cross-section of part of a lighting device made by this method is shown, for example in FIG. 1, wherein the light source (1) is attached to the light guide plate (3) with a reworkable optically clear adhesive film (2).

The adhesive film according to adhesive composition A exhibited excellent seal quality and provided a minimal gap between the light source and light guide plate. The small gap between the light source and light guide plate resulted in enhanced light efficiency utilization and lower power use.

1. A reworkable optically clear adhesive composition with a processing temperature of between about 50° C. and about 80° C. comprising:
from about 15 wt. % to about 40 wt. % hot melt adhesive;
from about 20 wt % to about 60 wt. % optical resin; and
from about 10 wt. % to about 40 wt. % UV adhesive,
wherein the weight percentage of each component is based on the total weight of the reworkable optically clear adhesive composition.

2. A reworkable optically clear adhesive composition according to claim 1, where the hot melt adhesive is selected from ethylene vinyl acetate, polypropylene, polyamide, polyurethane and combinations thereof.

3. A reworkable optically clear adhesive composition according to claim 1, where the optical resin is selected from polyacrylic, polymethylmethacrylate, polycarbonate, polyester, and cyclic olefin copolymer and combinations thereof.

4. A reworkable optically clear adhesive composition according to claim 1, where the UV adhesive is selected from epoxy adhesives, polyurethane acrylate adhesives, silicone adhesives and combinations thereof.

5. A reworkable optically clear adhesive composition according to claim 1, further comprising a catalyst in an amount of about 0.05 wt. % to about 0.15 wt. % based on the total weight of the reworkable optically clear adhesive composition.

6. A reworkable optically clear adhesive composition according to claim 5, wherein the catalyst is selected from sodium tantalite, titanium dioxide, dibutyl tin dilaurate, tetrabutyl titanate and nickel oxide.

7. A reworkable optically clear adhesive composition according to claim 1, wherein the adhesive composition is an adhesive film.

8. A reworkable optically clear adhesive composition according to claim 7, wherein the adhesive film has a thickness of about 5 μm to about 500 μm.

9. A method for adjoining a light source to a light guide plate comprising:
applying a reworkable optically clear adhesive composition with a processing temperature of about 50° C. to about 80° C. comprising:
from about 15 wt. % to about 40 wt. % hot melt adhesive;
from about 20 wt. % to about 60 wt. % optical resin; and
from about 10 wt. % to about 40 wt. % UV adhesive,
to alight source and/or a light guide plate to form a reworkable optically clear adhesive film, wherein the weight percentage of each component is based on the total weight of the reworkable optically clear adhesive composition; adjoining the light source to the light guide plate with the adhesive film therebetween; and
curing the reworkable optically clear adhesive film by treating with a UV light.

10. The method according to claim 9, wherein the light source is an LED bar.

11. The method according to claim 10, wherein the LED bar has a length of from about 0.01 m to about 2 m.

12. The method according to claim 9, wherein the light guide plate is selected from poly(methyl methacrylate), polycarbonate, acrylonitrile butadiene styrene and combinations thereof.

13. The method of claim 9, wherein the reworkable optically clear adhesive film applied to the light guide plate is heated to between about 50° C. and 80° C. and is removed and reapplied to the light guide plate.

14. The method of claim 9, wherein prior to treating with UV light the reworkable optically clear adhesive film is heated at a temperature between about 50° C. and about 80° C. for about 5 to about 20 minutes.

15. A lighting device comprising a light source, a light guide plate and a reworkable optically clear adhesive film, wherein the reworkable optically clear adhesive film has a processing temperature of between about 50° C. and about 80° C. and comprises:
from about 15 wt. % to about 40 wt,% hot melt adhesive;
from about 20 wt. % to about 60 wt. % optical resin; and
from about 10 wt. % to about 40 wt. % UV adhesive,
wherein the weight percentage of each component is based on the total weight of the reworkable optically clear adhesive film.
